(19) United States
(12) Patent Application Publication
(10) Pub. No.: US 2010/0189904 A1
(43) Pub. Date: Jul. 29, 2010

(54) FILM FORMING APPARATUS AND FILM FORMING METHOD USING THE SAME

(75) Inventor: Tomoyasu SAITO, Tachikawa-shi (JP)

Correspondence Address: BUCHANAN, INGERSOLL & ROONEY PC, POST OFFICE BOX 1404, ALEXANDRIA, VA, 22313-1404, US

(73) Assignee: CANON ANELVA CORPORATION, Kawasaki-shi (JP)

(21) Appl. No.: 12/725,722

(22) Filed: Mar. 17, 2010

Related U.S. Application Data
(63) Continuation of application No. PCT/JP2009/004847, filed on Sep. 25, 2009.

(30) Foreign Application Priority Data
Sep. 30, 2008 (JP) 2008-255181

(51) Int. Cl. B05D 3/02; B05C 9/14

(52) U.S. Cl. 427/372.2; 118/668

(57) ABSTRACT

A film forming apparatus includes a convey mechanism which conveys a substrate, a supply source which supplies a film formation material to form a film on the substrate conveyed by the convey mechanism, a shielding member which is positioned between the convey mechanism and the supply source to define, along a substrate conveying direction, a first area in which the substrate is shielded against supply of the film formation material, a second area which is adjacent to the first area and in which the film formation material is supplied to the substrate, and a third area which is adjacent to the second area and in which the substrate is shielded against supply of the film formation material, a first heating unit, a second heating unit, and a third heating unit which are respectively arranged in the first area, the second area, and the third area so as to heat the substrate conveyed by the convey mechanism and each include a plurality of heaters, a position detector which detects the position of the substrate in the conveying direction, and a controller which controls the first heating unit, the second heating unit, and the third heating unit. The supply source serves as a heat source, and the substrate conveyed by the convey mechanism is heated more strongly by the supply source when being positioned in the second area than when being positioned in the first area and the third area. The controller individually controls actuation of the first heating unit, the second heating unit, and the third heating unit so as to reduce temperature irregularity in the substrate in the conveying direction in accordance with the position of the substrate detected by the position detector.

### CROSS-REFERENCE TO RELATED APPLICATIONS

The present application is a continuation of PCT/JP2009/004847, filed Sep. 25, 2009, and which claims the priority of Japanese Application No. 2008-255181, filed on Sep. 30, 2008. The entire contents of PCT/JP2009/004847 and Japanese Application No. 2008-255181 are incorporated herein by reference.

### TECHNICAL FIELD

The present invention relates to a film forming apparatus, e.g., an in-line type film forming apparatus, and also to a film forming method using the apparatus.

### BACKGROUND ART

Along with increases in the size of flat-panel TV sets, a mainstream trend in deposition apparatuses for displays such as plasma displays is to perform multiple pattern deposition using large-sized substrates and high-throughput deposition. Deposition methods for deposition apparatuses mainly include an electron gun deposition method using electron beams, an ion plating method using plasma guns, and a sputtering method. All these deposition methods widely use an in-line system to form a film on a substrate while conveying it within a deposition chamber. Since film material formation sources in these methods are heat sources, substrate temperatures greatly rise due to the influences of heat sources.

A film forming apparatus has been proposed, which is configured to reduce temperature distribution differences on substrates by placing a plurality of points on a substrate along the direction in which the substrate is conveyed, at which a film formation material evaporates, separately providing a plurality of heaters for generating heat at the respective points, and individually providing the means to control the respective heaters and set their temperatures (patent reference 1).

FIG. 12 shows the film forming apparatus provided in patent reference 1. Patent reference 1 discloses a technique of setting the set temperature of a heater 2B′ on a ring hearth 3′ lower than that of other heaters 2A′ and 2C′ by 50° C., and preventing a rise in the temperature of a substrate 1 mounted on a carrier 4 by using a water-cooled opening limit plate 8. Note that the film forming apparatus in FIG. 12 includes an electron beam gun 3″ and the ring hearth 3′ in a vapor deposition chamber 10.

### CITATION LIST

### Patent Literature

Patent reference 1: Japanese Patent Laid-Open No. 2002-129311

### SUMMARY OF INVENTION

### Technical Problem

As shown in FIG. 12, however, in the film forming apparatus disclosed in patent reference 1, in a deposition state, the heaters are always ON in a vapor deposition area 2B′, an area 2A′ located before the vapor deposition area, and an area 2C′ located immediately after the vapor deposition area. For this reason, when a substrate enters the heating area 2A′ before the vapor deposition area, the leading end side of the substrate is heated, but a portion on the trailing end side of the substrate which has not entered the heating area is not heated. In addition, although the leading end side of the substrate is not heated immediately after it passes through the heating area 2C′ located immediately after the vapor deposition area, the rear portion of the substrate is heated. In this way, in the film forming apparatus disclosed in patent reference 1, a substrate has both a portion that is heated and a portion that is not heated, resulting in temperature irregularity along the direction in which it is conveyed, as well as cracking in the substrate.

It is an object of the present invention to provide a film forming apparatus that can reduce temperature irregularity in a substrate in the direction that it is being conveyed and a film forming method using the apparatus.

### Solution to Problem

According to the present invention, a film forming apparatus is provided which forms a film on a surface of a substrate, the apparatus comprising a convey mechanism which conveys a substrate, a supply source which supplies a film formation material to form a film on the substrate conveyed by the convey mechanism, a shielding member which is positioned between the convey mechanism and the supply source to define, along a substrate conveying direction, a first area in which the substrate is shielded against supply of the film formation material, a second area which is adjacent to the first area and in which the film formation material is supplied to the substrate, and a third area which is adjacent to the second area and in which the substrate is shielded against supply of the film formation material, a first heating unit, a second heating unit, and a third heating unit which are respectively arranged in the first area, the second area, and the third area so as to heat the substrate conveyed by the convey mechanism and each include a plurality of heaters, a position detector which detects a position of the substrate in the conveying direction, and a controller which controls the first heating unit, the second heating unit, and the third heating unit, wherein the supply source serves as a heat source, and the substrate conveyed by the convey mechanism is heated more strongly by the supply source when being positioned in the second area than when being positioned in the first area and the third area, and the controller individually controls actuation of the first heating unit, the second heating unit, and the third heating unit so as to reduce temperature irregularity in the substrate in the conveying direction in accordance with the position of the substrate detected by the position detector.

In addition, according to the present invention, there is provided a film forming method using the above film forming apparatus, wherein the first heating unit and the third heating unit are longer than a substrate conveyed in the conveying direction.

### ADVANTAGEOUS EFFECTS OF INVENTION

The present invention can provide a film forming apparatus and film forming method that can reduce temperature irregularity in a substrate in the conveying direction.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a view showing an example of a film forming apparatus according to the present invention;

FIG. 2 is a view showing a state before a substrate is subjected to a deposition process;

FIG. 3 is a view showing a state in which the front portion of a substrate is subjected to a deposition process;

FIG. 4 is a view showing a state in which the middle portion of the substrate is subjected to a deposition process;

FIG. 5 is a view showing a state in which the rear portion of the substrate is subjected to a deposition process;

FIG. 6 is a view showing a state immediately after the deposition process on the substrate;

FIG. 7 is a flowchart showing the contents of control by a controller;

FIG. 8 is a view showing a state in which a plurality of substrates are continuously subjected to deposition processes;

FIG. 9 is a view showing a state in which the plurality of substrates are continuously subjected to deposition processes;

FIG. 10 is a view showing a state in which the plurality of substrates are continuously subjected to deposition processes;

FIG. 11 is a view showing a state in which the plurality of substrates are continuously subjected to deposition processes;

FIG. 12 is a view showing a film forming apparatus according to the prior art;

FIG. 13 is a view showing a film forming apparatus including temperature detectors; and

FIG. 14 is a view showing a form of control on a heating unit.

### DESCRIPTION OF EMBODIMENTS

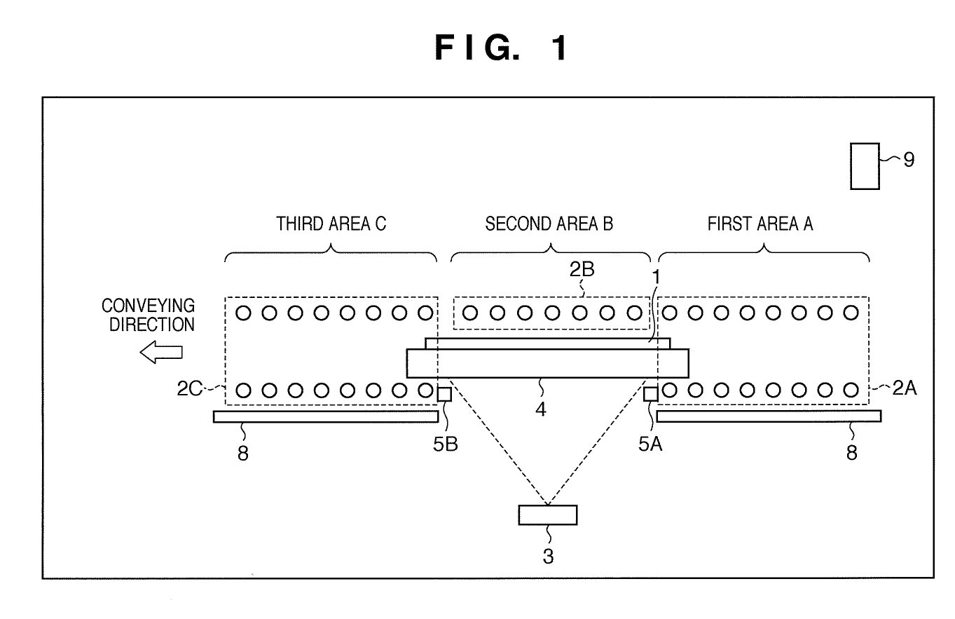

FIG. 1 shows an embodiment of a film forming apparatus according to the present invention that forms a film on the surface of a substrate. The film forming apparatus includes a convey mechanism 4 to convey a substrate 1 and a supply source 3 to supply a film formation material to form a film on the substrate 1 conveyed by the convey mechanism 4. The supply source 3 in this embodiment is an evaporation source. An electron emission source typified by an electron beam gun or plasma gun (not shown) emits an electron beam to the evaluation source to evaporate an evaporation material from the evaporation source 3. The evaporation source 3 also serves as a heat source.

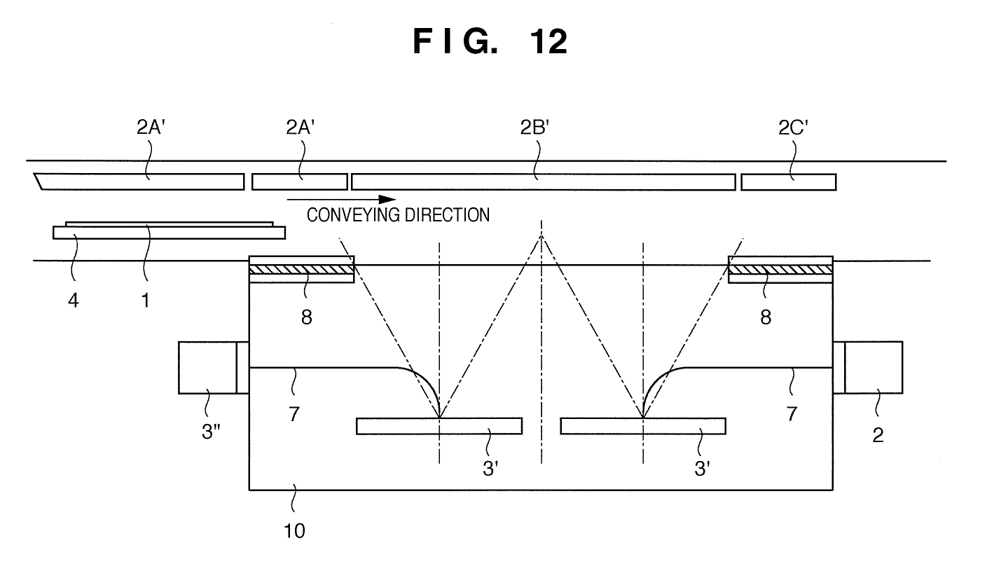

A shielding member 8 is disposed between the convey mechanism 4 and the evaporation source 3. As the shielding member 8, for example, the opening limit plate shown in FIG. 12 can be used, which has a central portion open to an evaporation area and includes a water cooling system. As shown in FIG. 1, the shielding member 8 defines a first area A, a second area B adjacent to the first area A, and a third area C adjacent to the second area B along the conveying direction of a substrate. In the first and third areas A and C, the shielding member 8 shields the evaporation material, and hence the material is not supplied to the substrate 1 during conveyance. In the second area B, the evaporation material is supplied to the substrate 1 during conveyance without being shielded by the shielding member 8. As described above, the evaporation source 3 serves as a heat source, and hence the conveyed substrate 1 is heated more strongly by the evaporation source 3 when the substrate 1 is located in the second area B than when the substrate 1 is located in the first and third areas A and C.

A first heating unit 2A, a second heating unit 2B, and a third heating unit 2C are respectively arranged in the first, second, and third areas A, B, and C to heat the substrate 1 conveyed by the convey mechanism 4. In this embodiment, the heating units 2A, 2B, and 2C each are a heater group including a plurality of heaters, as shown in FIG. 1. The heaters constituting the three heater groups 2A, 2B, and 2C are respectively arranged and fixed in the first, second, and third areas A, B, and C. The lengths of the first area A and first heating unit 2A and the length of the third area C and third heating unit 2C in the substrate conveying direction are set to be equal to or more than the length of the substrate 1.

Position detectors 5A and 5B to detect the position of the substrate 1 in the conveying path are installed at the two end portions of the second area B in the substrate conveying direction. The position detectors 5A and 5B detect the end portions (leading end portion and trailing end portion) of the conveyed substrate 1 in the conveying direction.

A controller 9 individually controls the three heating units 2A, 2B, and 2C. As will be described later, the controller 9 individually controls the actuation of the three heating units 2A, 2B, and 2C to reduce temperature irregularity in the substrate 1 in the conveying direction in accordance with the position of the substrate 1 detected by the position detectors 5A and 5B.

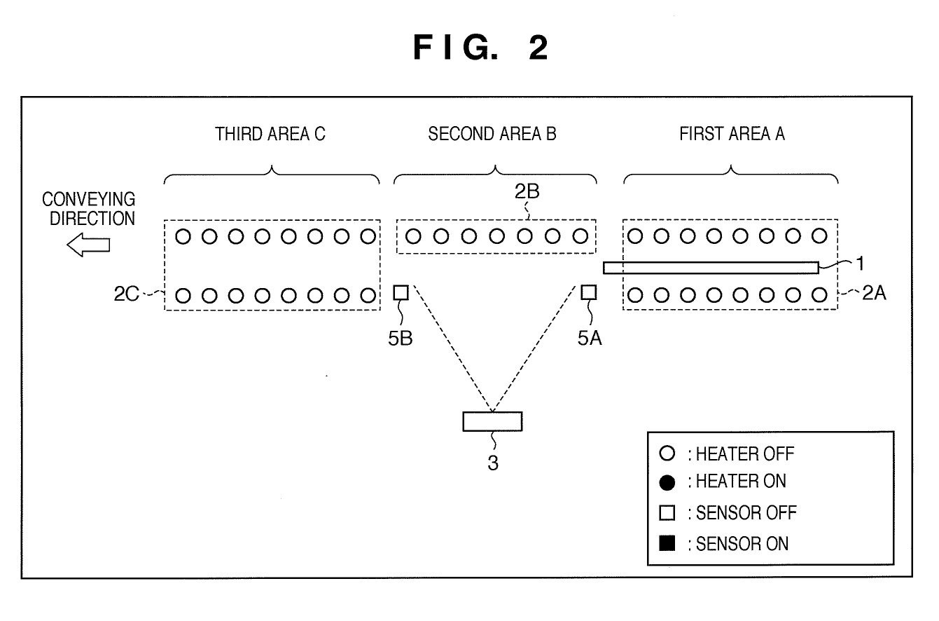

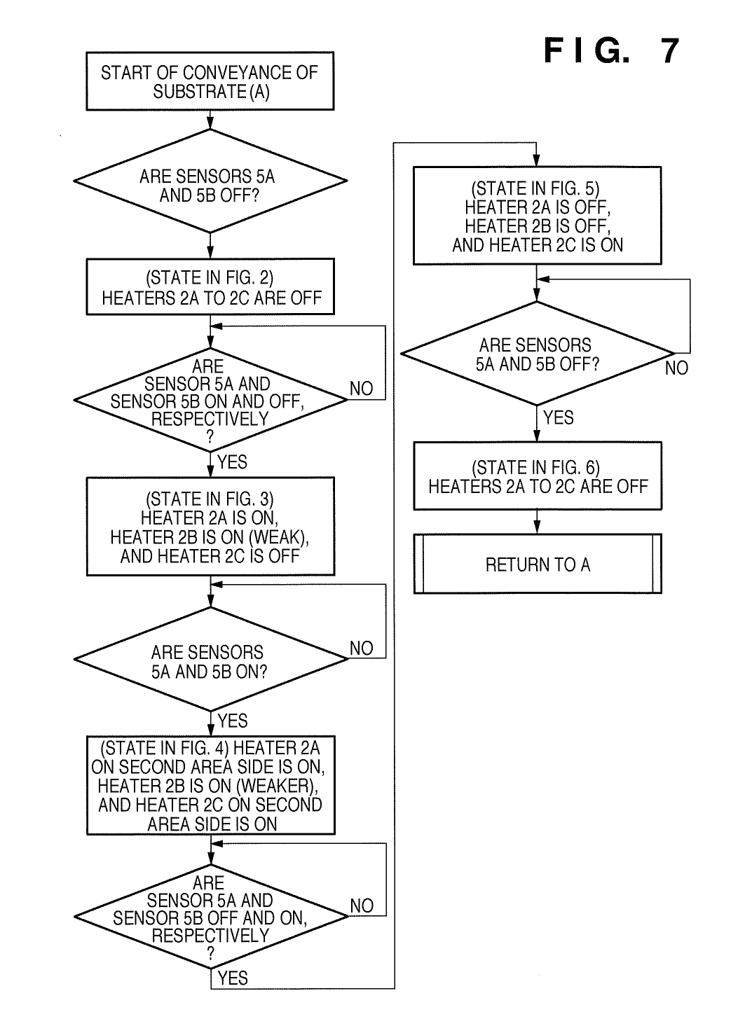

Control on the first to third heating units 2A, 2B, and 2C by the controller 9 will be described below with reference to FIGS. 2 to 7. In this case, this apparatus performs vapor deposition on the substrate 1 having a length longer than that of the second area B, which is a deposition area portion, in the conveying direction.

<Step 1>

In step 1, the substrate 1 exists in the first area A positioned upstream of the second area B which is a deposition area. Both the sensors 5A and 5B disposed near the entrance and exit of the second area B are OFF, and the controller 9 controls the three heating units 2A, 2B, and 2C to turn off all the heaters. Therefore, immediately before a deposition process, the substrate 1 receives no radiant heat from the heaters and the evaporation source 3, and hence no temperature irregularity has occurred in the substrate. FIG. 2 shows the state in step 1.

<Step 2>

The substrate 1 placed on the convey mechanism 4 is conveyed to enter the second area B as a deposition area. When the sensor 5A detects the leading end portion of the substrate 1, the controller 9 turns on the heaters of the first heating unit 2A, disposed in the first area A, which correspond to a portion in which the substrate 1 exists.

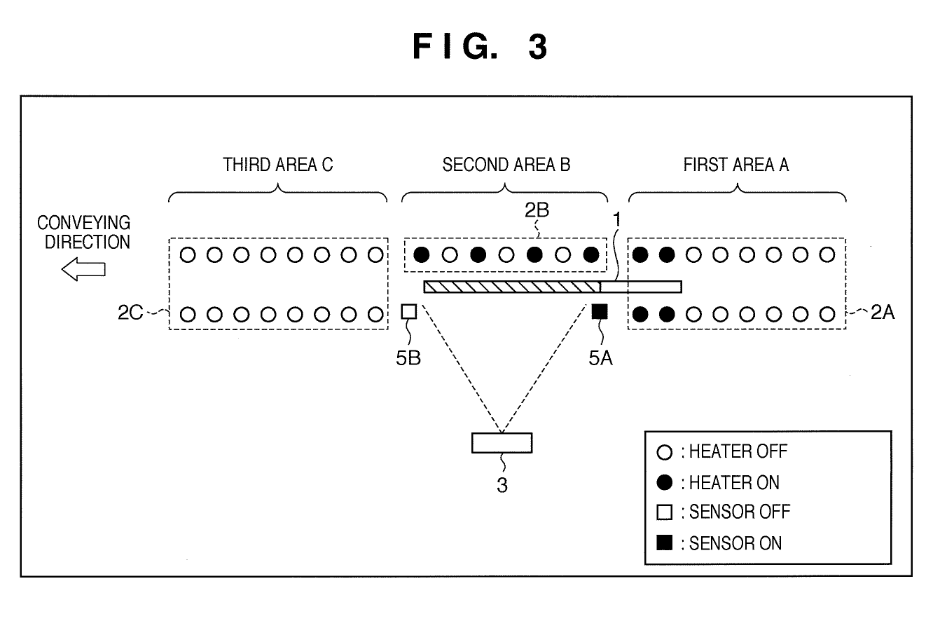

FIG. 3 shows a state in which the front half portion of the substrate 1 is subjected to deposition. In this state, the substrate 1 exists astride the first area A and the second area B, and only the sensor 5A is ON (is detecting the substrate). In this state, if the heaters provided for a deposition portion (hatched portion) and a non-deposition portion (non-hatched portion) generate heat with the same heating power, the substrate temperature at the deposition portion on the front side with a large heat input due to deposition rises more than the non-deposition portion on the rear side of the substrate. To prevent hits, in this embodiment, the controller 9 raises the temperature of the rear portion of the substrate 1, which is the non-deposition portion, by increasing the power of those of the heaters of the first heating unit 2A which are disposed at the non-deposition portion more than that of the second heating unit 2B at the deposition portion (hatched portion). This makes it possible to reduce the temperature irregularity in the substrate 1 in the conveying direction, thereby reducing the risk of substrate cracking. Since the first heating unit 2A is longer than the substrate 1, it is possible to heat the substrate 1 throughout its longitudinal direction by using the second heating unit 2B and the first heating unit 2A immediately after the leading end of the substrate 1 enters the second area B. As a consequence, a heated portion and a non-heated portion do not simultaneously exist on the substrate 1 unlike in patent reference 1. Note that the controller 9 determines a portion of the first area in which the substrate 1 exists, i.e., the range of heaters to be actuated in the first heating unit 2A, based on the timing at which the sensor 5A detects the leading end portion of the substrate 1 and the conveying speed of the substrate 1.

<Step 3>

When the substrate 1 is further conveyed and the sensor 5B detects the leading end portion of the substrate 1, the controller 9 turns on those of the heaters of the third heating unit 2C disposed in the third area C which are located near the deposition portion, and turns off the heaters of the first heating unit 2A which correspond to the portion in which the substrate 1 has ceased to exist. The controller 9 also decreases the power of the second heating unit 2B.

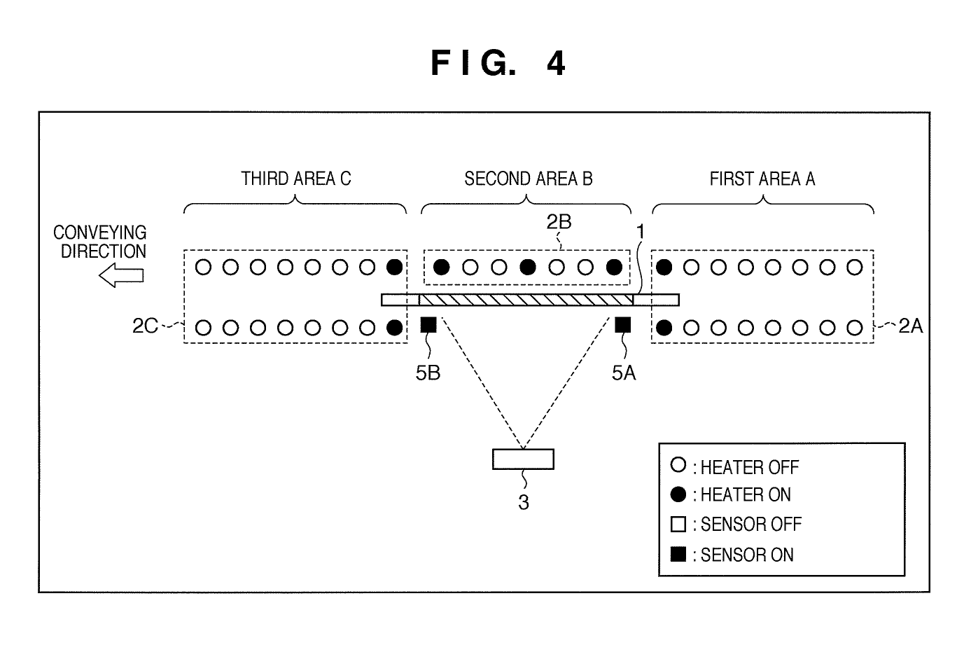

FIG. 4 shows a state in which the two sensors 5A and 5B are ON, i.e., a state in which the substrate 1 exists astride the first area A, second area B, and third area C. In this state, the prior art prevents a rise in the temperature of the substrate during deposition by setting in advance the heater temperature in the second area B, which is a deposition portion, lower than that of the first area A and third area C which are non-deposition portions. In contrast, this embodiment can further reduce a temperature rise on a deposition portion by decreasing the number of heaters actuated in the first heating unit 2A when the sensor 5B detects the substrate 1. It is then possible to reduce the temperature difference between the leading end portion of the substrate 1 and the deposition portion by actuating those of the heaters disposed in the first area A, second area B, and third area C which correspond to a portion in which the substrate 1 exists.

<Step 4>

When the substrate 1 further moves forward and the sensor 5A detects the trailing end portion of the substrate 1, the controller 9 stops heating in the first area A by turning off all the power of the first heating unit 2A in the first area A. The controller 9 also turns on those of the heaters of the third heating unit 2C disposed in the third area C which correspond to the portion which the substrate 1 has entered. In addition, the heaters of the second heating unit 2B, which corresponds to a deposition portion, are de-energized.

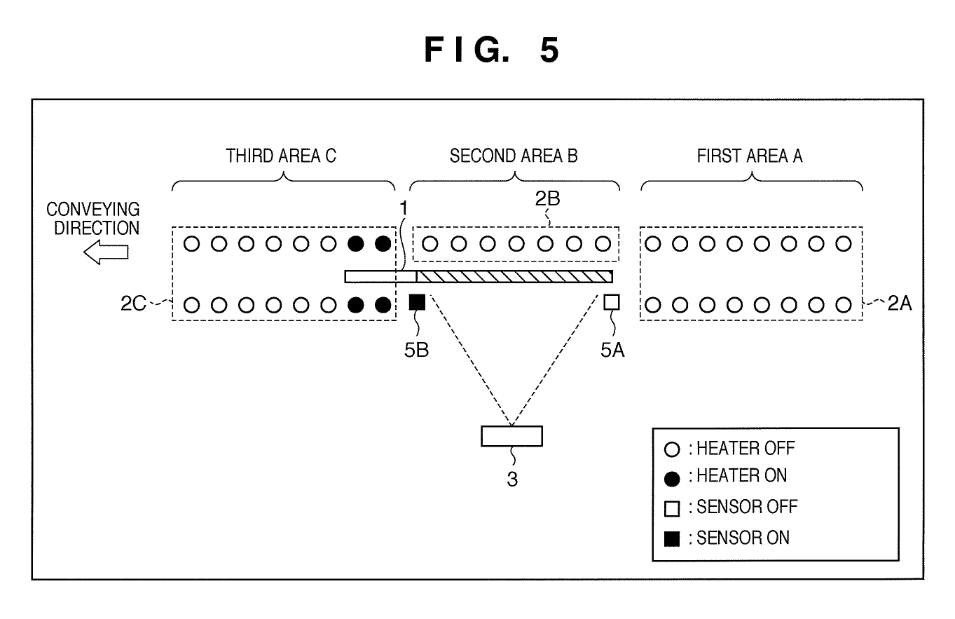

FIG. 5 shows a state in which only the sensor 5B of the two sensors is ON, i.e., a state in which the substrate 1 exists astride the second area B and the third area C. That is, the rear portion of the substrate 1 in the conveying direction is subjected to deposition.

Since the rear portion of the substrate 1 has already been heated by the heaters of the second heating unit 2B when the front portion of the substrate 1 is subjected to a deposition process, it is possible to prevent overheating at the rear portion of the substrate 1 by de-energizing the second heating unit 2B during deposition on the rear portion of the substrate 1. In addition, an abrupt temperature decrease after deposition on the substrate 1 can be prevented by increasing the heater power of those of the heaters of the third heating unit 2C which correspond to the portion in which the substrate 1 has entered the third area C.

In the conventional film forming apparatus shown in FIG. 12, in this state, the substrate temperature at the rear portion has risen more than that at the front portion having undergone deposition.

<Step 5>

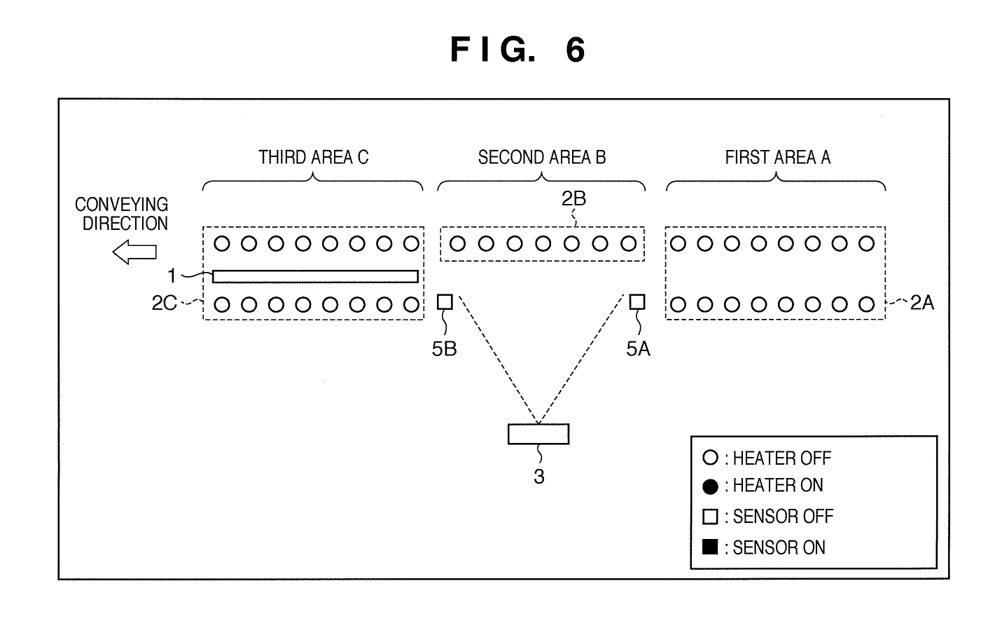

When the substrate 1 is further conveyed and entirely enters the third area C, the sensor 5B detects that the trailing end portion of the substrate 1 has moved from the second area B to the third area C. FIG. 6 shows this state, in which the substrate 1 entirely exists in the third area. The controller 9 turns off all the power of the heaters of the third heating unit 2C in accordance with the state in which both the sensors 5A and 5B are OFF. Therefore, no temperature irregularity occurs in the substrate 1 after deposition in the conveying direction.

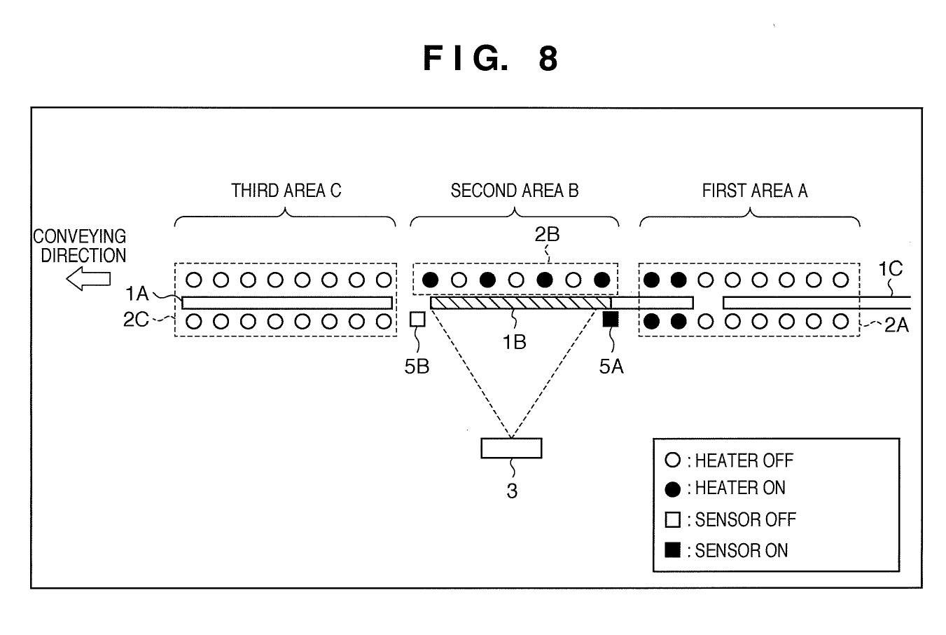

FIGS. 2 to 7 illustrate, by using one substrate, how the controller 9 performs control. The film forming apparatus according to this embodiment, however, can perform deposition by using a substrate whose length in the conveying direction is longer than the length of a deposition area, while conveying the substrate. A case in which deposition is performed while a substrate is continuously conveyed will be described below with reference to FIGS. 8 to 11.

<State in FIG. 8>

Substrates 1A to 1C placed on the convey mechanism 4 are conveyed in the conveying direction (the leftward direction in FIG. 8). When the sensor 5A detects the leading end portion of the substrate 1B, the controller 9 turns on all the heaters of the first heating unit 2A that correspond to the portion in which the substrate 1B exists. In this state, the substrate 1B is positioned astride the first area A and the second area B. The substrate. 1A located ahead of the substrate 1 is entirely positioned in the third area C that is an area in which a deposition process is complete.

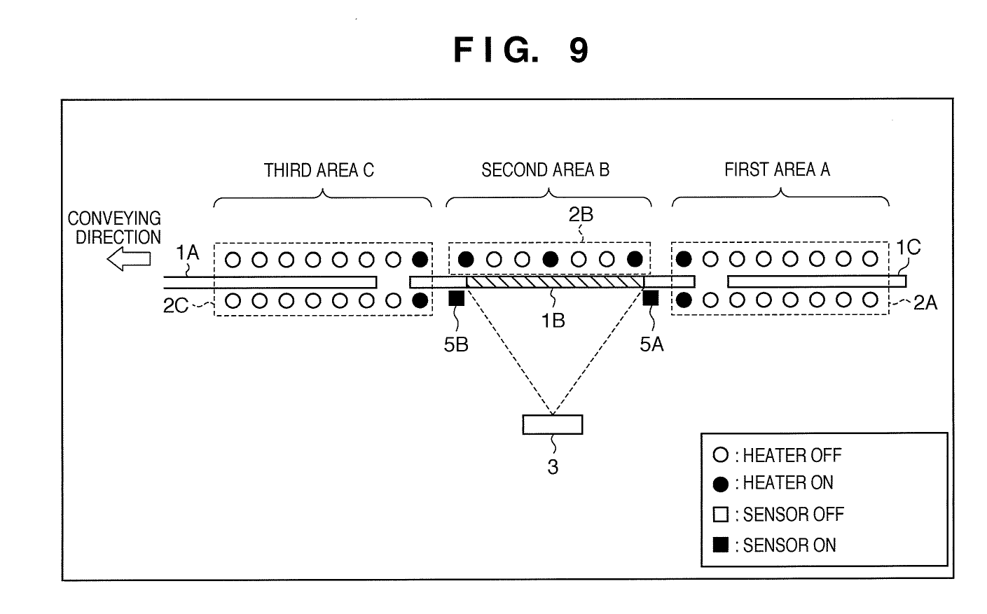

FIG. 8 shows a state in which the front portion of the substrate 1B is being subjected to deposition. In this state, only the sensor 5A is ON (is detecting the substrate). In this state, if all the heater groups 2A, 2B, and 2C generate heat with the same heating power, the substrate temperature at the front portion (hatched portion) of the substrate 1B with a large heat input due to deposition greatly rises as compared with the rear portion which is a non-deposition portion. In this embodiment, the controller 9 performs control to raise the temperature of the rear portion of the substrate 1B by increasing the power of those of the heaters of the first heating unit 2A which correspond to the portion in which the substrate 1B exists, more than that of the heaters of the second heating unit 2B. This makes it possible to reduce the temperature irregularity in the substrate 1B in the conveying direction, thereby reducing the risk of substrate cracking. In addition, since all the heaters of the third heating unit 2C are de-energized, the preceding substrate 1A having undergone deposition is not heated. This prevents the occurrence of temperature irregularity in the substrate due to heating of the trailing end portion of the substrate as in the prior art.

<State in FIG. 9>

When the substrate 1B is further conveyed and the sensor 5B detects the leading end portion of the substrate 1B, the controller 9 increases the power of the heaters of the heater group of the third heating unit 2C which are located near the deposition portion, and turns off the heaters of the first heating unit 2A except for the heaters located near the deposition portion. The controller 9 also decreases the power of the second heating unit 2B in the second area B that is the deposition portion.

In this state, both the two sensors 5A and 5B are ON. The substrate 1B exists astride the first area A, second area B, and third area C, and has a front portion having undergone deposition, a middle portion under deposition, and a rear portion immediately before deposition. In this state, the prior art prevents a temperature rise on a substrate during deposition by setting in advance the heater temperature at a deposition portion lower than that at a non-deposition portion. In contrast, this embodiment can further reduce a temperature rise on a deposition portion by decreasing the number of those of the heaters of the first heating unit 2A which are ON when the sensor 5B detects the entrance of the substrate 1B into the third area C. It is possible to reduce temperature irregularity in the substrate 1B in the conveying direction by actuating those of the heaters of the first heating unit 2A and third heating unit 2C which correspond to a portion in which the substrate 1B exists.

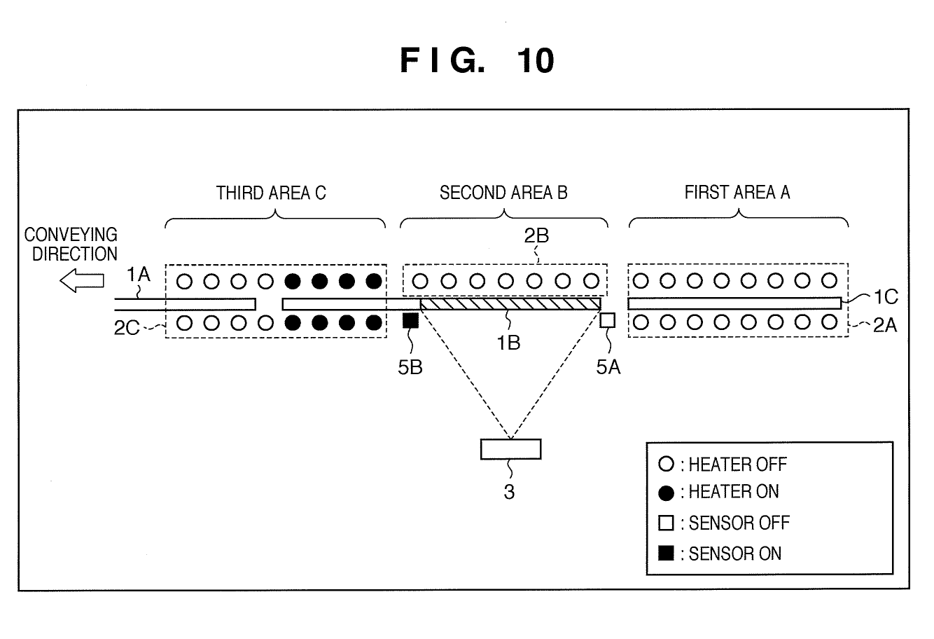

Actuating only those of the heaters of the third heating unit 2C which correspond to a portion in which the substrate 1B under deposition exists will inhibit heating of the preceding substrate 1A which has undergone a deposition process and is entirely positioned in the third area C. For this reason, no temperature irregularity occurs in the preceding substrate 1A. In addition, actuating only those of the heaters of the first heating unit 2A which correspond to a portion in which the substrate 1B under deposition exists will inhibit heating of the succeeding substrate 1C before deposition which is conveyed and positioned in the first area A. For this reason, no temperature irregularity occurs in the succeeding substrate 1C.

<State in FIG. 10>

The substrate 1B has further moved in the conveying direction and is positioned astride the second area B and the third area C. The succeeding substrate 1C is entirely positioned in the first area A. When the sensor 5A detects the trailing end portion of the substrate 1B, the controller 9 stops heating in the first area A by turning off the heaters of the first heating unit 2A which have generated heat. The controller 9 then turns on the heaters of the heater group of the third heating unit 2C that correspond to a portion which the substrate 1B has entered. In addition, the second heating unit 2B is de-energized.

In this state, only the sensor 5B at the exit side of the second area B is ON. The heaters of the first heating unit 2A have already heated the rear portion of the substrate 1B during a deposition process when a film is deposited on the front portion of the substrate 1B. Therefore, de-energizing the heater group of the second heating unit 2B that corresponds to the deposition portion when depositing a film on the rear portion of the substrate 1B can prevent overheating at the rear portion of the substrate 1B. In addition, increasing the number of those of the heaters of the third heating unit 2C that are actuated can prevent an abrupt temperature decrease at that portion of the substrate 1B positioned in the third area C which has undergone a deposition process.

If a conventional film forming apparatus like that shown in FIG. 12 is used, the substrate temperature at the rear portion of the substrate under deposition has risen as compared with the front portion of the substrate which has undergone deposition in this state.

In addition, in this state, since the first heating unit 2A is de-energized, no temperature irregularity occurs in the succeeding substrate 1C in the conveying direction.

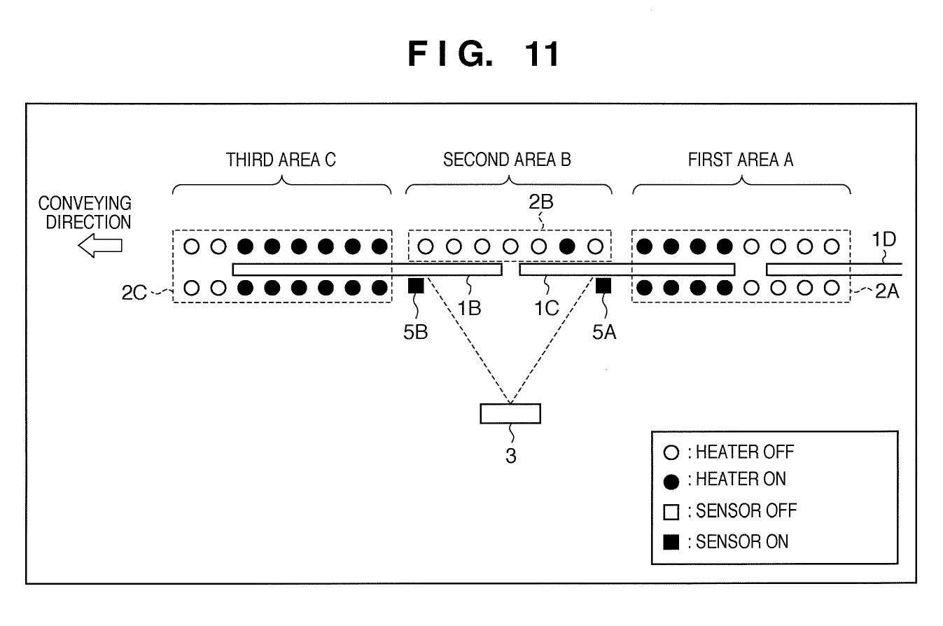

In this embodiment, even if the leading end portion of the succeeding substrate 1C is positioned in the front portion of the first area A, no heater heats the substrate unlike the prior art. When the front portion of the succeeding substrate 1C enters the second area B as a deposition area, since the front portion has not been preheated in the first area A, it is possible to reduce an excessive temperature rise on the front portion which enters the second area B and is subjected to a deposition process.

<State in FIG. 11>

When the substrate 1B and the succeeding substrate 1C move forward in the conveying direction and the sensor 5A detects the leading end portion of the succeeding substrate 1C, the controller 9 turns on the heaters of the first heating unit 2A which correspond to a portion in which the substrate 1C exists, thereby heating that portion of the succeeding substrate 1C which is position in the first area A. In addition, the controller 9 de-energizes the heaters located in the front half portion of the second heating unit 2B. On the other hand, the controller 9 turns on only those of the heaters of the third heating unit 2C that correspond to a portion in which the substrate 1B exists.

In this state, both the two sensors 5A and 5B disposed on the entrance side and exit side of the second area B are ON. In this state, this apparatus is depositing films on both the substrates, i.e., both the rear portion of the substrate 1B and the front portion of the substrate 10. In this state, there are temperature differences on the two substrates, i.e., the substrate 1B whose rear portion is subjected to deposition and the succeeding substrate 10 whose front portion is subjected to deposition. According to the prior art shown in FIG. 12, since this deposition portion is uniformly heated, temperature differences remain within the substrates. In contrast, this embodiment is configured to turn on only the heaters of the heater group of the second heating unit 2B that correspond to the front portion of the succeeding substrate 1C while de-energizing the heaters corresponding to the rear portion of the substrate 1B. This makes it possible to prevent overheating of the substrate 1B and underheating of the succeeding substrate 1C, thus improving temperature irregularity in both the substrates 1B and 10.

The sensors 5A and 5B detect the timings at which the leading end portions and trailing end portions of a plurality of substrates traveling on the convey path in the conveying direction enter and leave the second area B. The controller 9 can recognize the area in which each substrate exists based on the timings at which each substrate enters and leaves the second area B and the traveling speed of the substrate. The controller 9 then individually controls the actuation of the heater groups of the first to third heating units 2A, 2B, and 2C in accordance with the ranges of the areas in which the respective substrates exist. This reduces temperature irregularity in each of a plurality of substrates in the conveying direction. The controller 9 controls the respective heater groups based on set heater settings in accordance with the position of each substrate. The heater settings in this case indicate a set heating temperature, heater power, and the like.

The above embodiment is configured to individually control the actuation of the heaters of the first heating unit 2A and third heating unit 2C that correspond to non-deposition areas. However, it is possible to divide the heater groups of the first heating unit 2A and third heating unit into, for example, a plurality of groups and control power for each group. In addition, it is possible to detect the presence/absence of substrates in the first area A and the third area C by also disposing position sensors in the first area A and third area C.

In the above embodiment, in the first area A and the third area, the heaters are provided at both the upper and lower surfaces of a conveyed substrate. However, heaters can be provided at only the upper surface side opposite to the evaporation source. The embodiment has exemplified the case in which the film forming apparatus is a vapor deposition apparatus using an electron gun or a plasma gun. However, the present invention can be applied to in-line type film forming apparatuses including sputtering apparatuses in general.

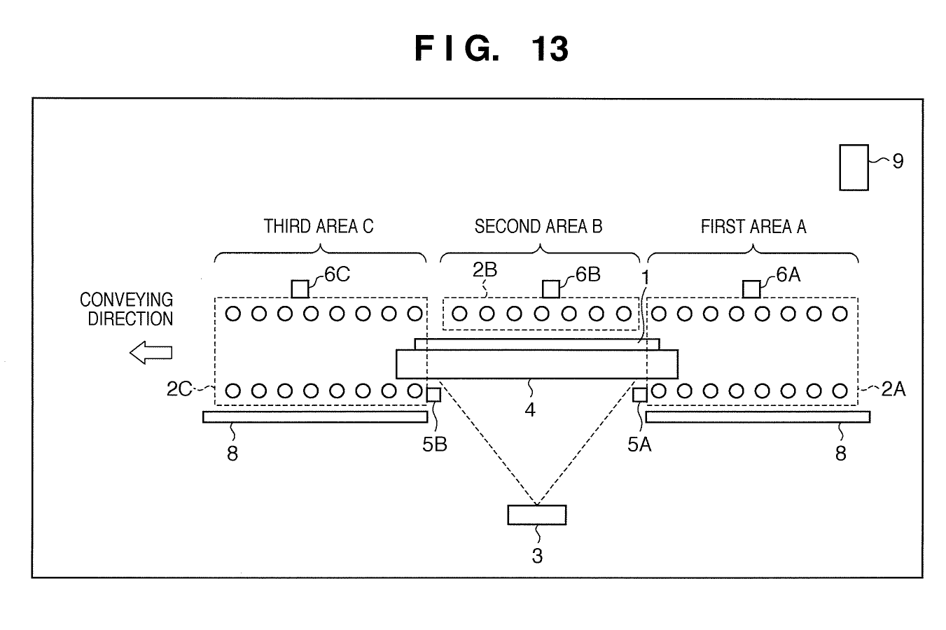

The above embodiment is configured to control the actuation of the heater groups of the first to third heating units 2A to 2C in accordance with the position of the substrate 1 detected by the position detectors 5A and 5B. However, it is possible to always control the power of each heater more properly by providing temperature sensors (e.g., radiation thermometers) 6A to 6C to detect the temperature of a substrate heated by the first to third heating units 2A to 2C and always measuring the temperature of the substrate 1 in addition to its position. As shown in FIG. 13, the temperature sensors 6A to 6C are provided near the areas in the first to third areas A to C through which the substrate 1 passes, e.g., above or below the areas through which the substrate passes. Assume that in the respective states in steps 1 to 5, the temperature of a substrate in each area is always measured, and the measured substrate temperature falls outside a preset range. In this case, it is possible to further reduce temperature irregularity in the entire substrate by changing the heater settings. The form of controlling the heaters in accordance with the position and temperature of the substrate 1 can also be applied to a case in which deposition is performed while a plurality of substrates are continuously conveyed.

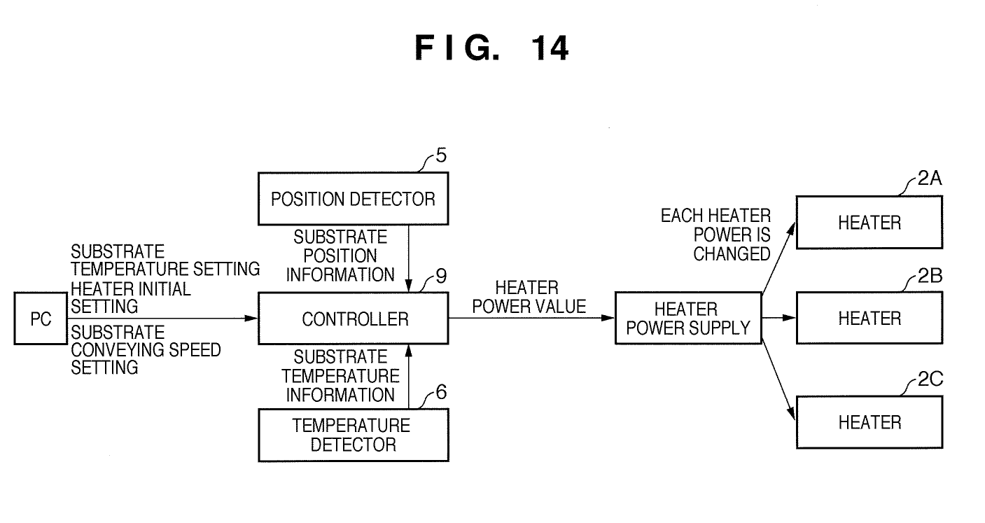

FIG. 14 shows a control model to control the power of each heater in accordance with the position and temperature of the substrate 1. The initial settings for each heater, substrate temperatures (an upper limit, a lower limit, and the like) at each position of the substrate, and the conveying speed of the substrate are set in apparatus operation software in a personal computer (to be referred to as a PC hereinafter) or the like. The set values are sent to the controller 9. Power values for the respective heaters of the heating units 2A to 2C which are calculated from information about the position and temperature of the substrate detected by a position detector 5 (position sensor 5) and a temperature detector 6 (temperature sensor 6) are sent to a heater power supply. The PC can set acquisition intervals for outputs from the position sensor 5 and the temperature sensor 6. It is possible to improve temperature irregularity in a substrate by changing the power of each heater based on output values sent at the intervals. In addition, when the substrate temperature detected by the temperature sensor 6 falls outside the allowable range of substrate temperatures set in the PC, the controller 9 can improve temperature irregularity in the substrate by changing the heater power on every such occasion based on the detected temperature.

The present invention is not limited to the above embodiments and various changes and modifications can be made within the spirit and scope of the present invention. Therefore, to apprise the public of the scope of the present invention, the following claims are made. This application claims the benefit of Japanese Patent Application No. 2008-255181 filed on Sep. 30, 2008, which is hereby incorporated by reference herein in its entirety.

1. A film forming apparatus that forms a film on a surface of a substrate, the apparatus comprising:
a convey mechanism which conveys a substrate;
a supply source which supplies a film formation material to form a film on the substrate conveyed by said convey mechanism;
a shielding member which is positioned between said convey mechanism and said supply source to define, along a substrate conveying direction, a first area in which the substrate is shielded against supply of the film formation material, a second area which is adjacent to the first area and in which the film formation material is supplied to the substrate, and a third area which is adjacent to the second area and in which the substrate is shielded against supply of the film formation material;
a first heating unit, a second heating unit, and a third heating unit which are respectively arranged in the first area, the second area, and the third area so as to heat the substrate conveyed by said convey mechanism and each include a plurality of heaters;
a position detector which detects a position of the substrate in the conveying direction; and
a controller which controls said first heating unit, said second heating unit, and said third heating unit,
wherein said supply source serves as a heat source, and the substrate conveyed by said convey mechanism is heated more strongly by said supply source when being positioned in the second area than when being positioned in the first area and the third area, and
said controller individually controls actuation of said first heating unit, said second heating unit, and said third heating unit so as to reduce temperature irregularity in the substrate in the conveying direction in accordance with a position of the substrate detected by said position detector.

2. The film forming apparatus according to claim 1, wherein said first heating unit and said third heating unit are longer than a substrate conveyed in the conveying direction.

3. The film forming apparatus according to claim 1, wherein the heaters of said first heating unit, said second heating unit, and said third heating unit are respectively arranged and fixed in the first area, the second area, and the third area.

4. The film forming apparatus according to claim 1, wherein said position detector detects an end portion of a conveyed substrate in the conveying direction.

5. The film forming apparatus according to claim 1, wherein said position detector is positioned at each of two end portions of the second area in the conveying direction.

6. The film forming apparatus according to claim 1, wherein
a substrate conveyed by said convey mechanism is longer than the second area in the conveying direction, and
said controller individually controls actuation of said first heating unit, said second heating unit, and said third heating unit in accordance with whether a conveyed substrate exists in the first area, exists astride the first area and the second area, exists astride the first area, the second area, and the third area, exists astride the second area and the third area, or exists in the third area.

7. The film forming apparatus according to claim 1, wherein
said convey mechanism continuously conveys a plurality of substrates,
said position detector detects a timing at which each of the plurality of conveyed substrates enters the second area and a timing at which each of the plurality of conveyed substrates leaves the second area, and
said controller determines whether each of the plurality of conveyed substrates exists in the first area, exists astride the first area and the second area, exists astride the first area, the second area, and the third area, exists astride the second area and the third area, or exists in the third area, based on timings at which each of the plurality of substrates enters and leaves the second area, which are detected by said position detector, and a speed at which each substrates is conveyed, and individually controls actuation of heaters included in said first heating unit, said second heating unit, and said third heating unit so as to reduce temperature irregularity in each of the plurality of substrates in the conveying direction in accordance with the determination result.

8. The film forming apparatus according to claim 1, the apparatus further comprising a temperature detector which detects a temperature of a substrate conveyed by said convey mechanism in the first area, the second area, and the third area,
wherein said controller individually controls actuation of said first heating unit, said second heating unit, and said third heating unit so as to reduce temperature irregularity in a substrate in the conveying direction in accordance with a position of the substrate which is detected by said position detector and a temperature of the substrate in the first area, the second area, and the third area which is detected by said temperature detector.

9. A film forming method using a film forming apparatus defined in claim 1, wherein the first heating unit and the third heating unit are longer than a substrate conveyed in the conveying direction.
